(19) United States
(12) Patent Application Publication
(10) Pub. No.: US 2008/0150400 A1
(43) Pub. Date: Jun. 26, 2008

(54) Electric machines, rotors, and rotor cages having reduced noise characteristics

(76) Inventor: James Robert Crowell, Huntertown, IN (US)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/643,459

(22) Filed: Dec. 21, 2006

(51) Int. Cl. H02K 5/06; H02K 5/24; H02K 9/06; H02K 3/12

(52) U.S. Cl. 310/60 R; 310/89; 310/201

(57) ABSTRACT

A cast rotor cage for an electric machine is provided. The rotor cage includes conductor bars, a first end ring, and a second end ring. The conductor bars have a first end and a second end. The first end ring is at the first end, while the second end ring is at the second end. The first end ring has a plurality of first fan blades, where at least some the first fan blades are asymmetrically disposed on the first end ring. Similarly, the second end ring has a plurality of second fan blades, where at least some the second fan blades are asymmetrically disposed on the second end ring.

### BACKGROUND OF THE INVENTION

1. Field of the Invention

The present disclosure is related to electric machines. More particularly, the present disclosure is related to electric machines, rotors, and rotor cages having reduced noise characteristics.

2. Description of Related Art

Alternating current (AC) electric machines such as electric motors, alternators, motor-generators, and the like are typically constructed with a stator and a rotor rotatably mounted with respect to the stator. In one particular type of electric machine, the stator is externally positioned relative to an internally rotating rotor.

In these internally rotating electric machines, the rotor typically includes a rotor core, a rotor cage, and a rotor shaft. The rotor core is constructed from a stack of generally circular laminations punched from suitable ferro-magnetic sheet material (e.g., a high magnetic permeability steel). Each of the laminations has a central opening and a plurality of notches arranged around the central opening near its outer margin. The laminations are assembled in a stack so as to form the rotor core with their central openings coaxially aligned to receive the rotor shaft extending longitudinally therethrough. The laminations in the stack are also arranged so that the notches form a number of slots extending longitudinally through the rotor core. Preferably, the laminations are slightly angularly displaced (e.g., skewed) from one another so that the slots are wrapped around the rotor core in spiral fashion.

Some rotors are cast rotors, where an aluminum alloy such as electric grade aluminum, is die cast into the slots and the end faces of the rotor core. For example, the molten aluminum can be forced under pressure through the slots to form conductor bars and to form suitable end rings, which are cast-in-place on the end faces of the core. The end rings connect the ends of the conductor bars. In some instances, the end rings also include cooling fan blades integrally cast with the end rings. The die cast rotor bars, end rings, and fan blades (when present) are collectively referred to as the rotor cage.

The electric machine produces heat in the stator windings in proportion to the amount of current flowing therethrough. Generally, the windings are cooled by the fan blades, which force air across the windings. Unfortunately, the fan blades generate an undesired noise level. Further, as the speed of the electric machine is increased, the undesired noise can increase beyond acceptable levels.

Accordingly, there is a need for electric machines, rotors, and rotor cages having fan blades that overcome, alleviate, and/or mitigate one or more of the aforementioned and other deleterious effects of the prior art.

### BRIEF SUMMARY OF THE INVENTION

Electric machines, rotors, and rotor cages are provided that include end rings having integrally cast fan blades that are asymmetrically aligned on the end rings. In some embodiments, the end rings and/or fan blades are beveled.

A cast rotor cage for an electric machine is provided. The rotor cage includes conductor bars, a first end ring, and a second end ring. The conductor bars have a first end and a second end. The first end ring is at the first end, while the second end ring is at the second end. The first end ring has a plurality of first fan blades, where at least some the first fan blades are asymmetrically disposed on the first end ring. Similarly, the second end ring has a plurality of second fan blades, where at least some the second fan blades are asymmetrically disposed on the second end ring.

A rotor for an electric machine is also provided that includes a rotor core, a rotor shaft, conductor bars in slots of the rotor core, a pair of end rings at opposite ends of the rotor core. The rotor shaft is concentrically disposed in the rotor core. The first end ring has a plurality of first fan blades, where at least some the first fan blades are asymmetrically disposed on the first end ring. Similarly, the second end ring has a plurality of second fan blades, where at least some the second fan blades are asymmetrically disposed on the second end ring.

An electric machine is provided that includes a stator having motor windings, a rotor rotatably disposed in the stator, and a pair of end rings at opposite ends of the rotor. The first end ring has a plurality of first fan blades, where at least some the first fan blades are asymmetrically disposed on the first end ring. Similarly, the second end ring has a plurality of second fan blades, where at least some the second fan blades are asymmetrically disposed on the second end ring.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective cut away view of an alternating electric machine revealing an exemplary embodiment of rotor according to the present disclosure;

FIG. 2 is an end view of an exemplary embodiment of electric machine of FIG. 1;

FIG. 3A is a side view of an exemplary embodiment of the end ring of FIG. 2;

FIG. 3B is a side view of an alternate exemplary embodiment of the end ring of FIG. 2;

FIG. 3C is a side view of another alternate exemplary embodiment of the end ring of FIG. 2;

FIG. 4 is an end view of a prior art electric machine;

FIG. 5 is a graph illustrating the peak noise generated by the electric machine of FIG. 1;

FIG. 6 is a graph illustrating the peak noise generated by the prior art electric machine of FIG. 4;

FIG. 7 is a perspective view of an exemplary embodiment of an end ring according to the present disclosure;

FIG. 8 is a plan view of the end ring of FIG. 7;

FIG. 9 is a sectional view taken along lines C-C of FIG. 8 illustrating the end ring;

FIG. 10 is a sectional view taken along lines B-B of FIG. 8 illustrating the end ring and fan blade;

FIG. 11 is a detail view of circle F in FIG. 8 illustrating the fan blade;

FIG. 12 is a detail view of circle E in FIG. 8 illustrating the balance correction feature; and

FIG. 13 is a sectional view taken along lines A-A of FIG. 12.

### DETAILED DESCRIPTION OF THE INVENTION

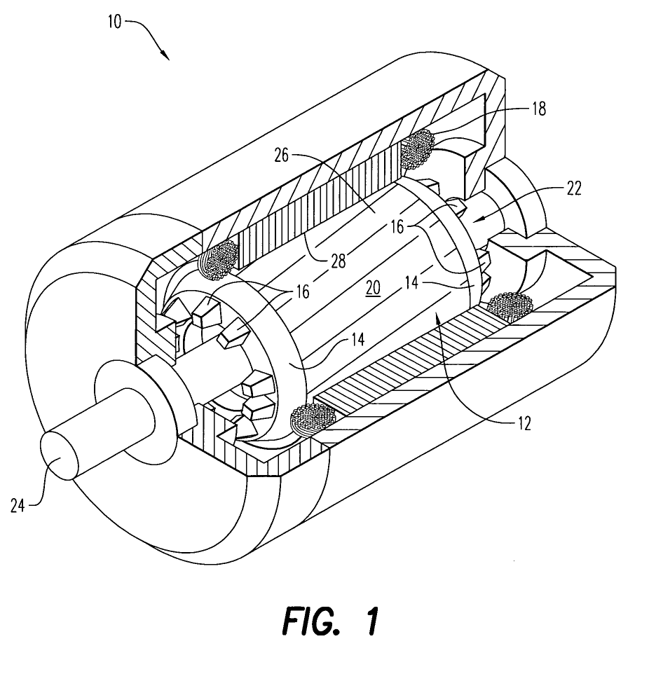

Referring to the drawings and in particular to FIG. 1, an exemplary embodiment of an electric machine according to the present disclosure is shown and is generally referred to by reference numeral 10. Machine 10 includes a rotor 12 having end rings 14 with a plurality of fan blades 16. Advantageously, end rings 14 and fan blades 16 are configured to reduce noise emitted by electric machine 10, while providing desired cooling levels to windings 18 of the motor.

Electric machine 10 is preferably an alternating current (AC) electric machine such as, but not limited to, an electric motor, an alternator, a motor-generator, and others. Rotor 12 includes a rotor core 20, a rotor cage 22, and a rotor shaft 24.

Fan blades 16 are illustrated for purposes of clarity as being blades for inducing a simple radial airflow (i.e., along the direction of shaft 24). However, fan blades 16 being configured to induce any desired airflow are contemplated for use in the present disclosure.

Rotor core 20 is constructed from a plurality of rotor laminations (not shown) in a known manner. Rotor cage 22 includes a plurality of conductor bars 26, a pair of end rings 14, and fan blades 16. In the illustrated embodiment, rotor cage 22 is a cast rotor cage made of, for example, an aluminum alloy. Here, rotor cage 22 includes integrally cast blades 16 on both end rings 14.

Rotor 12 is rotatably mounted with respect to a stator 28, through which windings 18 are wound. Stator 28 is also constructed in a known manner from a plurality of stator laminations (not shown).

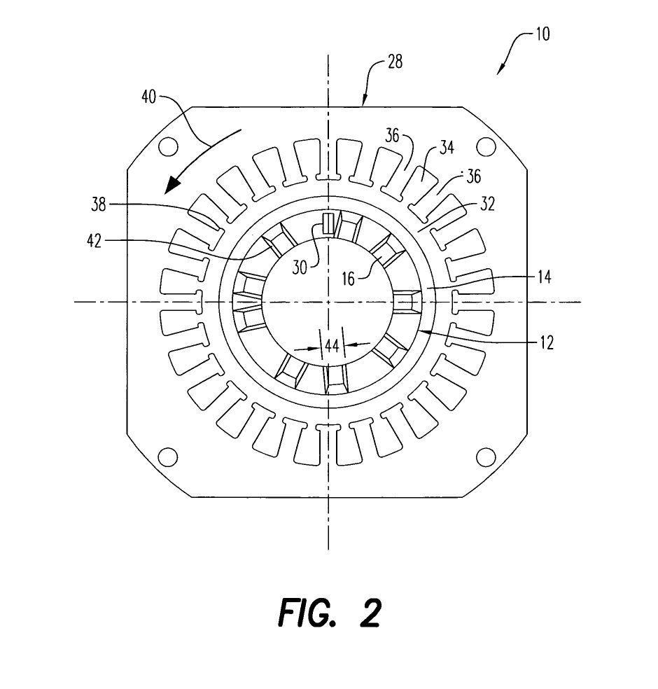

Electric machine 10 is illustrated in FIG. 2 in such a manner as to see the relationship between rotor 12 and stator 28. Thus, and for purposes of clarity, various components of electric machine 10 are omitted from FIG. 2.

Rotor 12 is mounted with respect to stator 28 so that an air gap 32 is defined between the outer circumference of the rotor and the inner circumference of stator 28.

Stator 28 includes a plurality of stator slots 34 in which windings 18 (not shown in FIG. 2 are wound. In the illustrated embodiment, stator 28 includes twenty-four (24) stator slots 34. Each stator slot 34 is defined between two adjacent stator teeth 36. Stator slots 34 and, thus, stator teeth 36, are evenly spaced about the inner circumference of stator 28. As such, each tooth 36 has a leading edge 38 (defined with respect to rotor direction 40) that is evenly spaced from one another.

Preferably, electric machine 10 is a bi-directional machine such that the electric machine is configured to rotate rotor 12 in a direction that is opposite to rotor direction 10. In this embodiment, end rings 14 have the same configuration on each side of rotor 12.

Advantageously, one or more fan blades 16 are asymmetrically disposed about end ring 14. It has been determined by the present disclosure that asymmetrical disposition of at least one fan blade 16 on end ring 14 reduces noise of electric machine 10.

As used herein, the term “asymmetrical fan blade” shall mean that fan blade 16 is disposed on end ring 14 in such a manner that a leading edge 42 (i.e., the edge in the direction of rotor direction 40) of that particular blade is unevenly spaced from the leading edges of one or more remaining blades on the end ring. Thus, the term “asymmetrical fan blade” can be used to describe the physical position of the fan blade on end ring 14 with respect to the other fan blades on the end ring.

Asymmetrical disposition of fan blade 16 ensures leading edge 42 of that blade does not pass the leading edge 38 of a stator tooth 36 at the same moment or time that other blades 16 on end ring 14 pass the leading edges 38 of other stator teeth 36 as the rotor rotates in direction 40. As such, the term “asymmetrical fan blade” can also be used to describe the physical position of the leading edge 42 of all fan blades 16 on a particular end ring 14 with respect to the leading edges 38 of the stator teeth 36.

In some embodiments, fan blades 16 all have the same width 44. In this embodiment an asymmetrical blade is a blade that is unevenly spaced from remaining blades on end ring 14. In other embodiments, some fan blades 16 can have a width 44 that is different than the width of other fan blades. In this embodiment, an asymmetrical blade is a blade that has a width that is larger or smaller than remaining blades on end ring 14. In still other embodiments, an asymmetrical blade 16 can be a blade that is unevenly spaced with respect to the remaining blades and has a width 44 that is different than the width of remaining blades. Thus, the asymmetric nature of fan blades 16 can be provided by varying the width and/or position of the blades with respect to one another.

Without wishing to be bound by any particular theory, it is believed that the noise produced by fan blades 16 passing fixed points (e.g., windings, stator teeth, etc) is the result of a pressure wave pulsation. The pulsation results from the air flow or pressure produced between the two adjacent blades. The pressure distribution in the air flow region between two blades is not completely uniform, however the width between to adjacent blades is certainly a factor in apparent pulsation magnitude and frequency. If balance is achieved by altering the relative width of one or more blades 16, the spacing between trailing and leading edges of adjacent blades is also, preferably, asymmetrical.

In a preferred embodiment, fan blades 16 all have the same width 44, height and other dimensions and the spacing of the blades is chosen to produce nearly prefect balance with the addition of a small balance correction included into the casting of end ring 14. In this manner, end ring 14 when applied to both ends of cast rotor 12 (with the ends rotated 180 degrees from each other) results in both static and dynamic balance, plus asymmetry of fan blades on each end, plus asymmetry or near asymmetry on both ends combined.

In the present disclosure, rotor 12 is said to have asymmetry on both ends combined when the leading edge 42 of all fan blades 16 do not pass the leading edge 38 of any stator tooth 36 at the same moment or time that other blades 16 on rotor 12 pass the leading edges 38 of other stator teeth 36 as the rotor rotates in direction 40.

In the illustrated embodiment, rotor 12 includes two end rings 14, each having nine (9) fan blades 16. However, it is contemplated by the present disclosure for each end ring 14 of rotor 12 to have any desired number of fan blades 16 including at least two (2) blades up to as many blades as can fit on the particular end ring 14.

It is also contemplated by the present disclosure as many of the fan blades to be asymmetrically disposed with respect to one another. In the illustrated embodiment, all eighteen fan blades are asymmetrically disposed with respect to one another. In another embodiment, sixteen fan blades are asymmetrically disposed with respect to one another, with two fan blades being identically positioned with respect to one another.

The selection of the number of blades 16 to be disposed on end ring 14 and/or the number of asymmetric blades is dependent upon, among other factors, the desired cooling rate of windings 18, the size of end ring 14, the rotational balance of rotor 12, and the size and/or power of electric machine 10.

In one exemplary embodiment, end rings 14 are identical to one another, but are offset from one another by 180 degrees in order to ensure that rotor 12 is rotationally balanced.

In some embodiments, only one blade 16 is asymmetrically disposed on each end ring 14. Preferably, each blade 16 is asymmetrically disposed on each end ring 14. Thus, one, several or all of blades 16 can asymmetrically disposed on each end ring 14. The selection of the number of blades 16 to be asymmetrically disposed on end ring 14 is dependent upon, among other factors, the desired cooling rate of windings 18, the rotational balance of rotor 12, the size of end ring 14, the size and/or power of electric machine 10, as well as the desired noise limit for the electric machine.

In one embodiment, end ring 14 includes a balance correction feature 30. Balance correction feature 30 assists in achieving a low residual unbalance in rotor 12. Advantageously, feature 30 is cast into end ring 14 since in the production of high speed cast rotors the removal of material from the rotor and/or the addition of balance weights were determined by the present disclosure to be impractical. Balance correction feature 30 allows an additional degree of freedom in balancing rotor 12. It has been determined by the present disclosure that, when using a blade 16 having a common width 44, with asymmetrical spacing of all blades, the addition of balance correction feature 30 provides a simple design that is a) balanced, b) asymmetrically spaced leading edges, and c) asymmetrical spacing of the air flow gap regions.

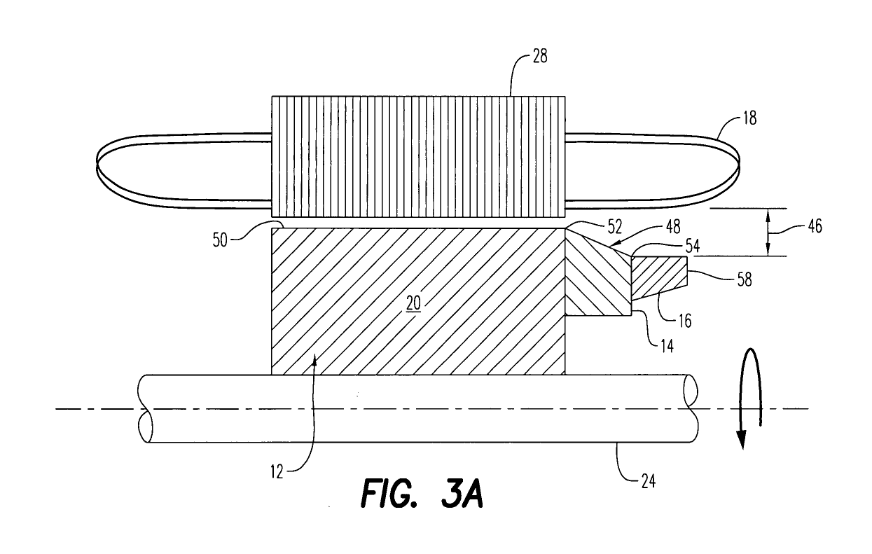

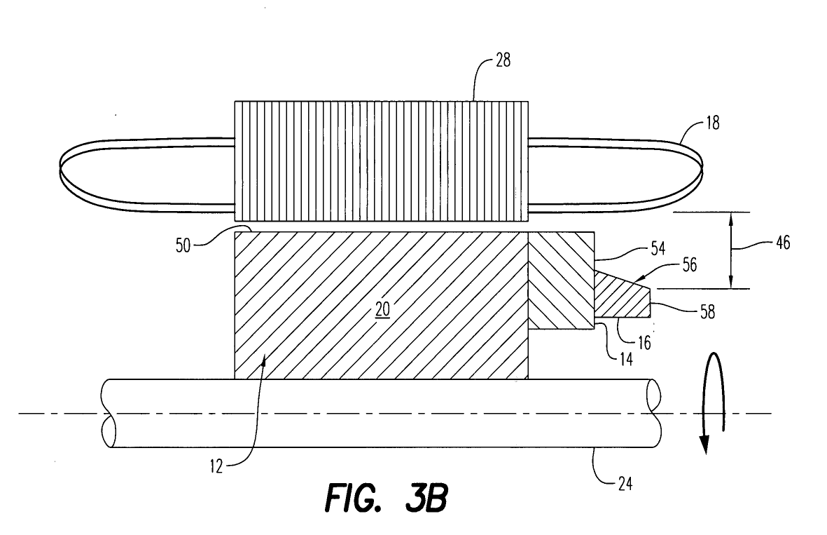

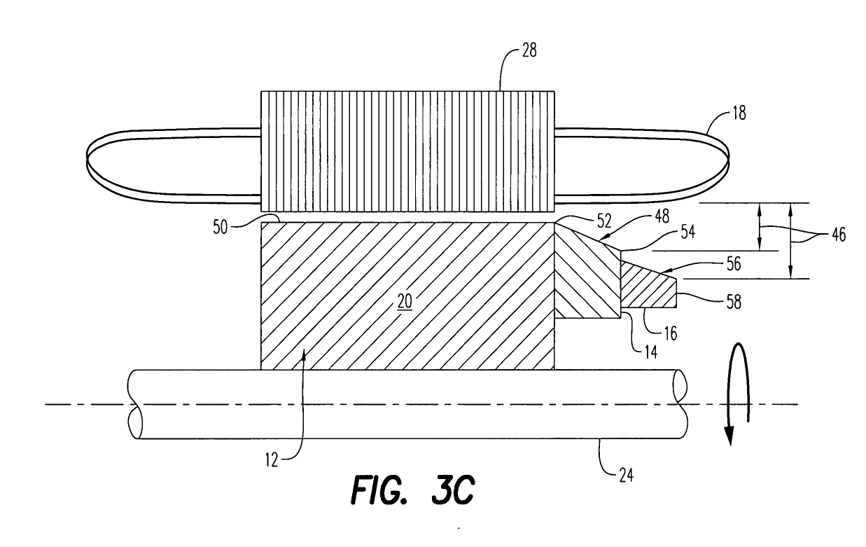

FIG. 3 are side views of exemplary embodiments of the end ring 14 and fan blades 16 of FIG. 2. For purposes of clarity, only one fan blade 16 is shown. Advantageously, end ring 14 and/or fan blade 16 can be configured with a variable distance between the end ring/blade and the winding 18.

More particularly, it has also been determined by the present disclosure that a distance 46 of end ring 14 (FIG. 3A) and, in some embodiments of both end ring 14 and fan blade 16 (FIG. 3B), and in other embodiment of only fan blades 16 (FIG. 3C), from winding 18 can be varied to reduce the noise of electric machine 10.

In the illustrated embodiment of FIG. 3A, end ring 14 includes a first bevel 48, which varies distance 46 of the end ring from winding 18. In the illustrated embodiment, first bevel 48 begins at an end face 50 of rotor 12 (i.e., the outer diameter of the end ring) and terminates at an end face 54 of the end ring. However, it is contemplated by the present disclosure for any portion of the end ring 14 that faces stator 28 or windings 18 to include first bevel 48. Advantageously, it has been determined by the present disclosure that increasing the distance of end ring 14 from winding 18 is a contributing factor in reducing noise induced by rotor 12.

First bevel 48 is illustrated by way of example as having a linear slope. However, it is contemplated by the present disclosure for first bevel 48 to have any desired slope including linear, non-linear, and any combinations thereof.

In the illustrated embodiment shown in FIG. 3B, fan blades 16 include second bevel 56, which varies distance 46 of the fan blade from winding 18. However, end ring 14 does not include first bevel 48. Advantageously, it has also been determined by the present disclosure that increasing the distance 46 of fan blades 16 from winding 18 is a contributing factor in reducing noise induced by rotor 12.

In the illustrated embodiment, second bevel 56 begins at end face 54 of end ring 14 and terminates at an end face 58 of fan blade 16. However, it is contemplated by the present disclosure for any portion of the fan blade 16 that faces windings 18 to include second bevel 56.

Second bevel 56 is illustrated by way of example as having a linear slope. However, it is contemplated by the present disclosure for second bevel 56 to have any desired slope including linear, non-linear, and any combinations thereof.

In the illustrated embodiment shown in FIG. 3C, end ring 14 includes first bevel 48 and fan blade 16 includes second bevel 56, which vary the distance 46 of the end ring and the fan blade, respectively, from winding 18. Advantageously, it has been determined by the present disclosure that increasing the distance 46 of both fan blades 16 and end ring 14 from winding 18 can further reduce noise induced by rotor 12.

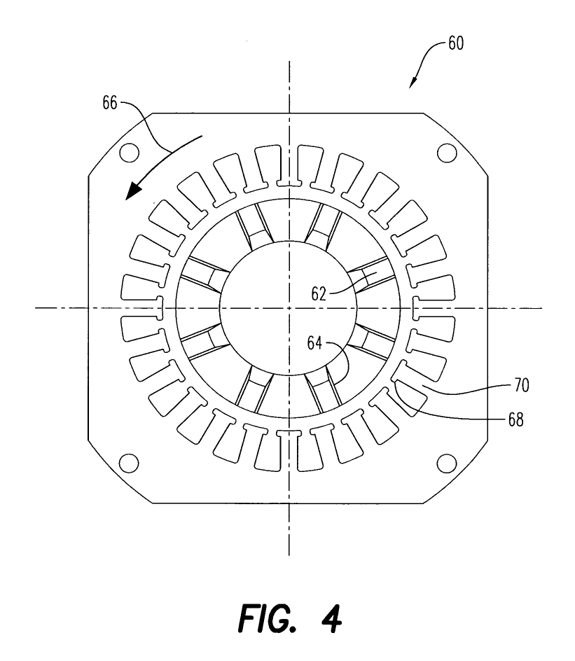

Referring now to FIG. 4, a prior art electric machine 60 is shown having symmetrical fan blades 62. As such, the leading edge 64 (defined with respect to rotor direction 66) of symmetrical blades 62 all pass the leading edge 68 of stator teeth 70 at the same moment.

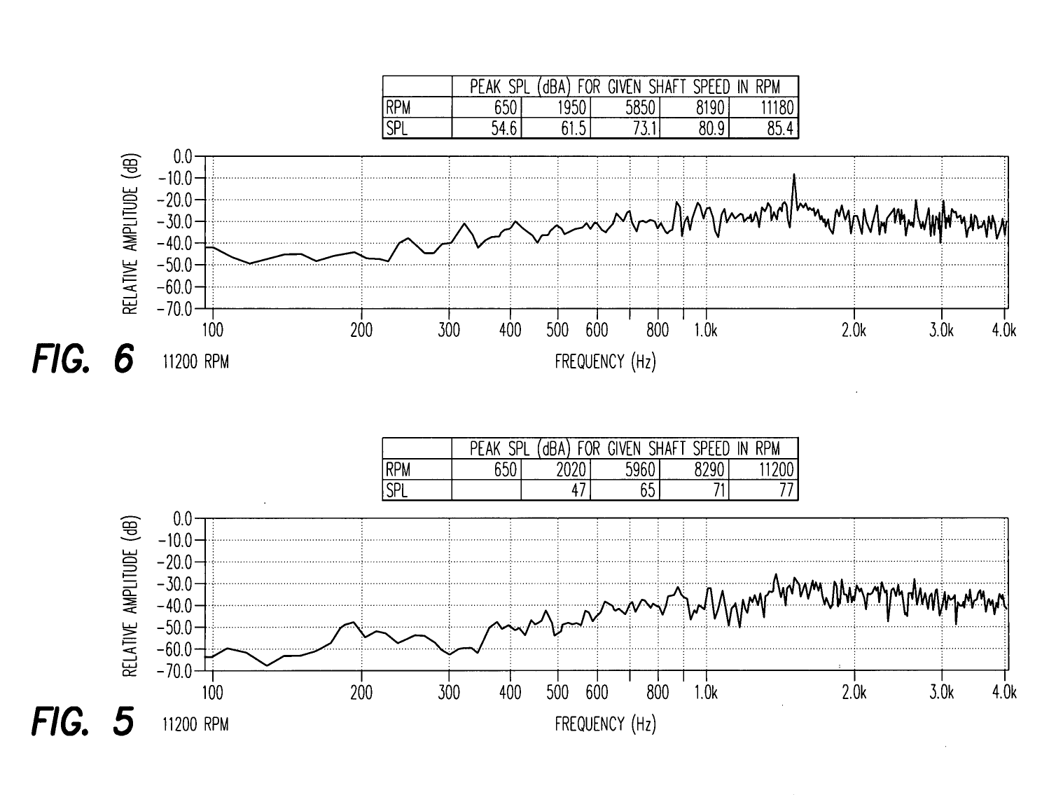

An exemplary embodiment of the noise reduction available from electric machine 10 according to the present disclosure as compared to prior art electric machine 60 can be seen with simultaneous reference to FIGS. 5 and 6. FIG. 5 illustrates the relative amplitude in decibels (dB) and frequency in hertz (Hz) of electric machine 10 according to the present disclosure illustrated in FIGS. 2 and 3 having nine (9) asymmetrical fan blades 16. In contrast, FIG. 6 illustrates the relative amplitude in decibels (dB) and frequency in hertz (Hz) of the prior art electric machine 60 having eight (8) symmetrical fan blades.

During testing, the electric machine used was a motor that was mounted so that the motor shaft was directed vertically downward. During the test, the only rotor of the electric machine was replaced. As such, the stator and motor windings remained the same in both tests.

An Extech SPL sound meter was placed 12 inches from the electric machine. In each case, the electric machine was accelerated to 650 revolutions per minute (RPM) of the motor shaft, 1950 RPM, 5850 RPM, 8190 RPM, and 11,180 RPM and then allowed to coast down. FIGS. 5 and 6 represent the data collected during acceleration to and coast down from 11,180 RPM.

As can be seen, electric machine 10 (FIG. 5) provides an overall noise reduction of about 7 dB as compared to the prior art electric machine 60 (FIG. 6) when operating at 11,000 RPM, without affecting the heat removal rate of the fan. Further, the noise spike in the 1.0 kilo HZ to 2.0 kilo HZ range of the prior art electric machine 60 (FIG. 6) has advantageously been eliminated by electric machine 10 (FIG. 5) of the present disclosure.

Accordingly, electric machine 10 having rotor 12 of the present disclosure results in significant noise level reduction at high speed (e.g., between about 8,500 RPM to about 11,000 RPM or higher). The design reduces the two highest factors in noise, the siren effect and the reinforcement from symmetry, while allowing the fan to remain bi-directional.

Electric machine 10 finds particular use in household appliances such as, but not limited to, vertical and horizontal axis cloths washing machines.

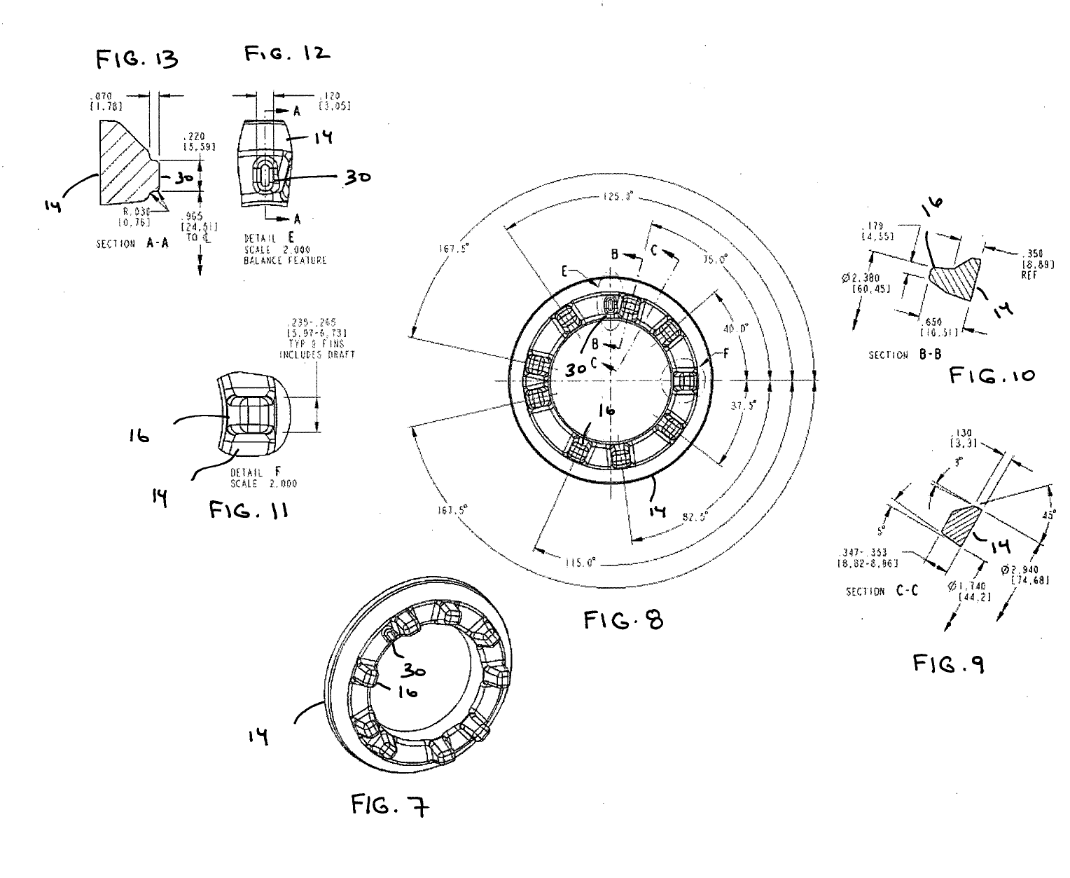

Referring now to FIGS. 7 through 13, an exemplary embodiment of end ring 14 having fan blades 16 and balance correction feature 30 according to the present disclosure is shown.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A cast rotor cage for an electric machine, comprising:
a plurality of conductor bars having a first end and a second end;
a first end ring at said first end, said first end ring having a plurality of first fan blades, at least some first fan blades of said plurality of first fan blades being asymmetrically disposed on said first end ring; and
a second end ring at said second end, said second end ring having a plurality of second fan blades, at least some second fan blades of said plurality of second fan blades being asymmetrically disposed on said first end ring.

2. The cast rotor cage of claim 1, wherein said first and second end rings each comprise a first bevel at a winding facing portion of the cast rotor cage.

3. The cast rotor cage of claim 2, wherein said first bevel has a slope selected from the group consisting of linear, a non-linear, and any combinations thereof.

4. The cast rotor cage of claim 2, wherein each fan blade of said first and second plurality of fan blades comprise a second bevel at said winding facing portion.

5. The cast rotor cage of claim 4, wherein said second bevel has a slope selected from the group consisting of linear, a non-linear, and any combinations thereof.

6. The cast rotor cage of claim 1, wherein each fan blade of said first and second plurality of fan blades comprise a second bevel at a winding facing portion of the cast rotor cage.

7. The cast rotor cage of claim 1, wherein all of said first fan blades of said plurality of first fan blades are asymmetrically disposed on said first end ring.

8. The cast rotor cage of claim 1, wherein all of said first and second fan blades of said plurality of first and second fan blades have asymmetry to one another.

9. The cast rotor cage of claim 1, wherein said first and second end rings are identical to one another but are offset from one another by 180 degrees.

10. The cast rotor cage of claim 1, wherein said first and second end rings further comprise an integrally cast balance correction feature.

11. A rotor for an electric machine, comprising:
a rotor core having a first end and a second end;
a rotor shaft concentrically disposed in said rotor core;
a plurality of conductor bars disposed in slots of said rotor core;,
a first end ring at said first end, said first end ring having a plurality of first fan blades, at least some first fan blades of said plurality of first fan blades being asymmetrically disposed on said first end ring; and
a second end ring at said second end, said second end ring having a plurality of second fan blades, at least some second fan blades of said plurality of second fan blades being asymmetrically disposed on said first end ring.

12. The rotor of claim 11, wherein said first and second end rings each comprise a first bevel at a winding facing portion of the rotor.

13. The rotor of claim 12, wherein each fan blade of said first and second plurality of fan blades comprise a second bevel at said winding facing portion.

14. The rotor of claim 11, wherein each fan blade of said first and second plurality of fan blades comprise a second bevel at a winding facing portion of the rotor.

15. The rotor of claim 11, wherein all of said first and second fan blades of said plurality of first and second fan blades have asymmetry to one another.

16. An electric machine comprising:
a stator having motor windings;
a rotor having a first end and a second end, said rotor being rotatably disposed in said stator;
a first end ring at said first end, said first end ring having a plurality of first fan blades, at least some first fan blades of said plurality of first fan blades being asymmetrically disposed on said first end ring; and
a second end ring at said second end, said second end ring having a plurality of second fan blades, at least some second fan blades of said plurality of second fan blades being asymmetrically disposed on said first end ring.

17. The electric machine of claim 16, wherein said first and second end rings each comprise a first bevel at a winding facing portion of said rotor.

18. The electric of claim 17, wherein each fan blade of said first and second plurality of fan blades comprise a second bevel at said winding facing portion.

19. The electric of claim 16, wherein each fan blade of said first and second plurality of fan blades comprise a second bevel at a winding facing portion of said rotor.

20. The electric machine of claim 16, wherein all of said first and second fan blades of said plurality of first and second fan blades have asymmetry to one another.
